(19) United States
(12) Patent Application Publication
(10) Pub. No.: US 2025/0214481 A1
(43) Pub. Date: Jul. 3, 2025

(54) APPARATUS AND METHOD FOR MANAGING A SITUATION OF AN ELECTRIC VEHICLE BATTERY

(71) Applicant: SAMSUNG SDI CO., LTD., Yongin-si (KR)

(72) Inventor: Min Su KIM, Suwon-si (KR)

(21) Appl. No.: 18/883,702

(22) Filed: Sep. 12, 2024

(30) Foreign Application Priority Data
Dec. 27, 2023 (KR) 10-2023-0192251

(51) Int. Cl. B60L 58/10

(52) U.S. Cl. CPC B60L 58/10; B60L 2240/62; B60L 2250/10

(57) ABSTRACT

An apparatus for managing a situation of an electric vehicle battery is disclosed. The apparatus for managing a situation of an electric vehicle battery includes a battery management module configured to monitor a state of the battery mounted in a vehicle, a communication module configured to transmit or receive information about the situation of the battery to or from a surrounding, a warning module configured to warn of the situation of the battery, and a processor operatively coupled to the battery management module, the communication module, and the warning module, wherein the processor determines the situation based on state information of the battery received from the battery management module, and outputs the information about the situation through at least one of the warning module or the communication module.

### CROSS-REFERENCE TO RELATED APPLICATION

The present application claims priority and the benefit of Korean Patent Application No. 10-2023-0192251, filed on Dec. 27, 2023 in the Korean Intellectual Property Office, the entire disclosure of which is incorporated herein by reference.

### BACKGROUND

### 1. Field

The present disclosure relates to an apparatus and method for managing a situation of an electric vehicle battery.

### 2. Discussion of the Related Art

An electric vehicle is a vehicle that is operated using electricity and is provided with a battery for supplying the electricity for driving the vehicle. In particular, in pure-electric or fully-electric vehicles and plug-in type hybrid electric vehicles, a battery is charged using power supplied from an external power source, and an electric motor is driven using the power charged in the battery.

Although such electric vehicles have many environment and maintenance advantages, there may be various problems in the stability of battery packs.

In particular, a fire risk due to overheating, thermal runaway, or the like of a battery pack may be one risk factor of the electric vehicle.

A battery management system (BMS) may manage charging and discharging of the battery while monitoring a charging state, a voltage, a current, and the like of the battery to help optimize the performance of the battery pack, secure safety, and increase a lifetime of the battery.

When the battery experiences overheating, thermal runaway, or the like, a risk of fire may occur which may be dangerous if the vehicle is parked in a parking lot or parking tower. The ability of a current parking lot system in actively responding to a fire risk of an electric vehicle may be limited. Thus, it may be difficult to perform an initial response to the fire to minimize damage or effectively control the fire.

The above-described information described in the background technology of this disclosure is only for facilitating understanding of the background of the present disclosure and therefore may also include information that does not constitute the related art.

### SUMMARY

According to an aspect of one or more embodiments of the present disclosure, an apparatus and method for managing a detected situation, condition, or state (e.g., an abnormal situation) of an electric vehicle battery is provided, including determining the situation of the battery and providing an alert to address the situation.

However, technical objectives to be solved by the present disclosure are not limited to the above-described objectives, and other objectives which are not described above will be clearly understood by those skilled in the art from the following description of example embodiments of the present disclosure.

According to one or more embodiments of the present disclosure, there is provided an apparatus for managing a situation of an electric vehicle battery, the apparatus including a battery management module configured to monitor a state of the battery mounted in a vehicle, a communication module configured to transmit or receive information about the situation of the battery to or from a surrounding, a warning module configured to warn of the situation of the battery, and a processor operatively coupled to the battery management module, the communication module, and the warning module, wherein the processor is configured to determine the situation based on state information of the battery received from the battery management module, output the information about the situation through at least one of the warning module or the communication module.

In some embodiments, the state of the battery includes at least one of a temperature, a voltage, or a charging state of the battery.

In some embodiments, the communication module is configured to perform wireless transmission and reception with the surrounding using a 900 MHz industrial scientific medical (ISM) band.

In some embodiments, the processor is configured to: classify the situation of the battery according to a level; and determine a severity level.

In some embodiments, the processor is configured to transmit the severity level and location information of the vehicle through the communication module.

In some embodiments, the processor is configured to: encrypt the information with an authentication key of the vehicle and transmit the information through the communication module; and verify validity of a received signal.

In some embodiments, the processor encrypts the information based on a public key and a private key.

In some embodiments, the apparatus further comprises an autonomous driving module configured to autonomously drive the vehicle, wherein, based on the processor receiving a second information about a second situation of a second battery from a second vehicle through the communication module, the processor is configured to drive the autonomous driving module to move the vehicle to a location outside a set range.

One or more embodiments of the present disclosure also include a method of managing a situation of an electric vehicle battery, the method comprising: receiving, by a processor, state information of the battery mounted in a vehicle from a battery management module; determining, by the processor, the situation based on the state information of the battery; and outputting, by the processor, information about the situation through at least one of a warning module or a communication module based on determining the situation.

One or more embodiments of the present disclosure also include a method of managing a situation of an electric vehicle battery, the method comprising: receiving, by a processor, information about the situation of the battery from a communication module; and outputting, by the processor, the information about the situation through a warning module in response to the receiving of the information about the situation of the battery.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure is not to be construed as being limited to the drawings.

FIG. 1 is a schematic block diagram illustrating a configuration of an apparatus for managing a detected (e.g., an abnormal) situation of an electric vehicle battery according to one embodiment of the present disclosure;

FIG. 2 is a conceptual layout diagram illustrating an example structure of a data packet transmitted through the apparatus for managing a detected (e.g., an abnormal) situation of an electric vehicle battery according to one embodiment of the present disclosure;

FIG. 3 is a flowchart of an example method for managing a detected (e.g., an abnormal) situation of an electric vehicle battery according to one embodiment of the present disclosure; and

FIG. 4 is a flowchart of an example method for managing a detected (e.g., an abnormal) situation of an electric vehicle battery according to another embodiment of the present disclosure.

### DETAILED DESCRIPTION

Hereinafter, embodiments of the present disclosure will be described, in detail, with reference to the accompanying drawings. The terms or words used in this specification and claims are not to be construed as being limited to the usual or dictionary meaning and are to be interpreted as having meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not necessarily represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are the same or “substantially the same.” Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it will be understood that when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

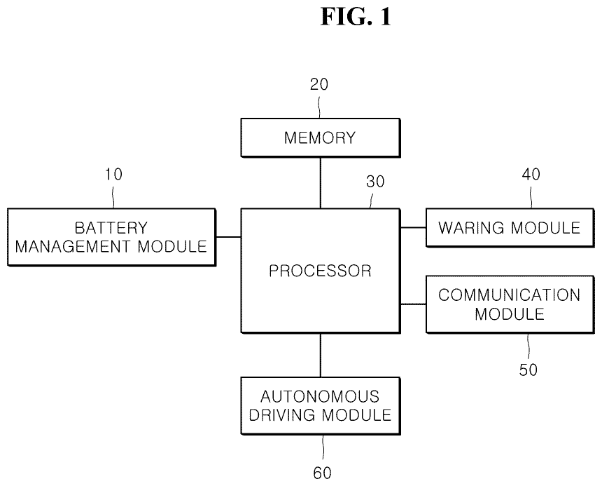

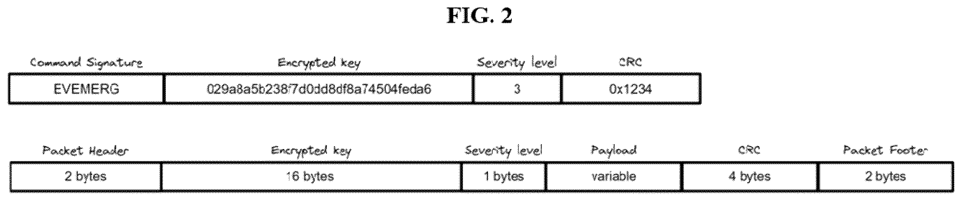

FIG. 1 is a schematic block diagram illustrating a configuration of an apparatus for managing a detected (e.g., an abnormal) situation, condition, or state (collectively referenced as a detected situation) of an electric vehicle battery according to one embodiment of the present disclosure. FIG. 2 is a conceptual layout diagram illustrating an example structure of a data packet transmitted through the apparatus for managing a detected (e.g., an abnormal) situation of an electric vehicle battery according to one embodiment of the present disclosure.

As illustrated in FIG. 1, the apparatus for managing a detected (e.g., an abnormal) situation of an electric vehicle battery according to one embodiment of the present disclosure may include a battery management module 10, a communication module 50, a warning module 40, an autonomous driving module 60, a memory 20, and a processor 30. The one or more modules 10, 40, 50, and 60 may be implemented via software, firmware, hardware, or a combination of software, firmware, and/or hardware, which may be installed within an electric vehicle equipped with the electric vehicle battery. For example, the one or more modules 10, 40, 50, and 60 may be implemented as computer program instructions that are stored in memory (e.g., memory 20) which, when executed by a processor (e.g., processor 30), cause the processor to implement the functionalities of the modules. Also, although the one or more modules 10, 40, 50, and 60 are assumed to be separate functional units, a person of skill in the art will recognize that the functionality of the modules may be combined or integrated into a single module, or further subdivided into further sub-modules without departing from the spirit and scope of the inventive concept.

The battery management module 10 may be configured to manage charging and discharging of the battery while monitoring a charging state, a voltage, a temperature, and the like (collectively referred to as a state of the battery) to optimize the performance of the battery mounted on an electric vehicle, to secure safety, and/or increase a lifetime of the battery.

The communication module 50 may be configured to transmit or receive information (e.g., abnormal situation information) of a battery to or from the surroundings.

In some embodiments, the communication module 50 may perform wireless transmission and reception with the surroundings using a 900 MHz industrial scientific medical (ISM) band, although embodiments are not limited thereto, and may include other radio frequency bands as will be appreciated by a person of skill in the art.

The warning module 40 may be configured to warn a driver and nearby people (e.g., via audio, text, graphics, and/or the like) about a detected (e.g., an abnormal) situation of the battery so that the driver and nearby people may recognize or be alerted to the detected (e.g., abnormal) situation of the battery.

The autonomous driving module 60 may be configured to control, without limitation, a steering device, a driving device, and a braking device of the vehicle to drive the vehicle to a destination. In some embodiments, a nearby vehicle may be moved to a location outside a set range from the vehicle with the battery in the detected (e.g., abnormal) situation.

The memory 20 may store an execution program (e.g., computer program instructions) related to or for performing an operation of the apparatus for managing a detected (e.g., an abnormal) situation of an electric vehicle battery, and information to be stored may be selected by the processor 30 as necessary.

In some embodiments, the memory 20 stores various types of data generated in a process for executing an operating system (O/S) or application (program or applet) for driving the apparatus for managing a detected (e.g., an abnormal) situation of an electric vehicle battery and various commands. In some embodiments, the memory 20 may be implemented as a non-volatile memory, a volatile memory, a flash-memory, a hard disc drive (HDD), a solid-state drive (SSD), etc. In addition, the memory 20 may be accessed, and data reading/recording/modification/deletion/update may be performed by the processor 30.

The processor 30 may be operatively coupled to the battery management module 10, the communication module 50, the warning module 40, the autonomous driving module 60, and the memory 20. The processor 30 may be configured to execute at least one command stored in the memory 20 for controlling an overall operation of the apparatus for managing a detected (e.g., an abnormal) situation of an electric vehicle battery, and may store data of an executing result thereof in the memory.

In some embodiments, the processor 30 may be configured to manage the apparatus for managing a detected (e.g., an abnormal) situation of an electric vehicle battery. The processor 30 may be implemented as a central processing unit (CPU) or a system on chip (SoC). The processor 30 may drive the O/S or application to control one or more hardware or software components connected to the processor, and may perform processing and calculation on various types of data.

In some embodiments, the processor 30 may receive state information of the battery from the battery management module 10 and determine a situation such as an abnormal charging state in which a temperature is out of a threshold range associated with a normal range or a voltage satisfies a certain criterion (e.g., is unstable).

As described above, the processor 30 may determine a situation of the battery, determine a severity level such as a first (e.g., a warning) level, a second (e.g., a caution) level, or a third (e.g., a dangerous) level based on the determination, output information about the detected situation through the warning module 40 and the communication module 50, receive a detected (e.g., abnormal) situation information of a second battery from a nearby vehicle through the communication module 50, and output the information about the detected (e.g., abnormal) situation through the warning module 40. The information output by the processor may include a command or signature indicative of the detected situation.

In some embodiments, if the severity level is determined, the first level (e.g., a warning level) indicates a first (e.g., an initial) state in which a temperature of the battery exceeds the threshold range associated with a normal range or the voltage meets a certain criterion (e.g., is in an unstable state), and the driver may be notified of the detected (e.g., abnormal) symptom to prompt the driver to take an action in advance or in response to the notification.

The second (e.g., caution) level may indicate a state of the battery is degraded (e.g., continuously degraded) and a temperature of the battery as having increased or a voltage as being unstable, and signal the vehicle to stop, and/or the driver to call a service center or expert to take action.

The third (e.g., dangerous) level may indicate a battery state (e.g., serious battery state) in which an action (e.g., an urgent action) may be required, indicate that a temperature of the battery is increased over a threshold (e.g., an ignition) temperature, and/or signal the driver to escape (e.g., immediately) from the vehicle and notify nearby people of a risk.

In some embodiment, if the processor 30 outputs a detected (e.g., abnormal) situation information through the communication module 50, the processor 30 may transmit the severity level and location information of the vehicle.

In some embodiments, the processor 30 may perform encryption and transmission using an encryption mechanism that may use a public key and a private key together with a unique authentication key, to allow the validity of a received signal to be verified.

In some embodiments, if the processor 30 transmits a detected (e.g., abnormal) situation information of the battery and encryption is performed through the private key, decryption may be performed by a receiving vehicle through the public key, and the validity of the received signal may be verified. Further, the reliability of the signal may be secured, and malfunction may be prevented.

In some embodiments, the processor may output a detected (e.g., abnormal) situation information through a data packet having a structure illustrated in FIG. 2.

In some embodiments, the data packet may logically include a command signature field, an encrypted key field, a severity level field, and a cyclic redundancy check (CRC) field.

As described above, a unique signature may be inserted into a start portion of the data packet so that an emergency signal is recognized. An encrypted unique authentication key and a severity level of the vehicle may be transmitted through respectively the encrypted key field and the severity level field. A CRC code for verifying accuracy of the data packet may be transmitted through the CRC field.

For example, if the data packet including the above-described logical fields is formed, the data packet may include a 2-byte packet header, a 16-byte encrypted key field, a 1-byte severity level field, a variable-byte payload field, a 4-byte CRC field, and a 2-byte packet footer.

In some embodiments, the processor 30 receives information about a detected (e.g., abnormal) situation from a transmitting vehicle located within a set range to a receiving vehicle, on the basis of location information received from the transmitting vehicle. In some embodiments, the processor 30 in the receiving vehicle may output the abnormal situation information through the warning module 40. In some embodiments, the transmitting vehicle and the receiving vehicle are both equipped with the apparatus for managing a detected situation of its electric vehicle battery described with respect to FIG. 1.

In some embodiments, if the autonomous driving module 60 which autonomously drives the electric vehicle (e.g., receiving vehicle) is included and the processor 30 receives information about a detected (e.g., abnormal) situation of a battery from a nearby (e.g., transmitting) vehicle through the communication module 50, the processor 30 may drive the autonomous driving module 60 to move the vehicle to a location outside a set range.

In some embodiments, if the processor 30 of the receiving vehicle receives information about a detected (e.g., abnormal) situation of the battery (e.g., from a transmitting vehicle) and a severity level is a third (e.g., dangerous) level, the processor 30 may set a safe location outside a set range as a destination and drive the autonomous driving module 60 to move the vehicle away from the transmitting vehicle.

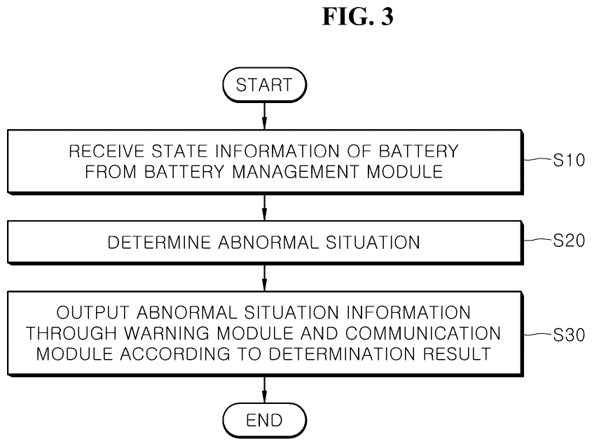

FIG. 3 is a flowchart of an example method for managing a detected (e.g., an abnormal) situation of an electric vehicle battery according to one embodiment of the present disclosure.

As illustrated in FIG. 3, in the method for managing a detected (e.g., an abnormal) situation of an electric vehicle battery according to one embodiment of the present disclosure includes the processor 30 of a first electric vehicle executing an execution program stored in the memory 20 and receiving state information of the battery mounted in the first vehicle from the battery management module 10 (S10).

In some embodiments, the state information of the battery may include one or more among a temperature, a voltage, and a charging state of the battery.

Based on receiving the state information of the battery, the processor 30 detects a situation (e.g., an abnormal situation) from the received state information of the battery (S20).

In some embodiments, the processor 30 may receive the state information of the battery from the battery management module 10 and determine a situation (e.g., an abnormal situation) such as a case in which the charging state is abnormal, for example, a temperature exceeds a normal range or a voltage is unstable.

As described above, the processor 30 may determine the situation (e.g., an abnormal situation) of the battery, classify the abnormal situation of the battery according to a level, and determine a severity level such as a first (e.g., warning) level, a second (e.g., caution) level, or a third (e.g., dangerous) level.

In some embodiments, if the severity level is determined, the first (e.g., warning) level indicates an initial state in which a temperature of the battery exceeds a normal range or an unstable state of a voltage occurs, and signals a driver of the first vehicle may be notified to the detected (e.g., an abnormal) symptom to prompt the driver to take an action in advance or in response to the signal.

The second (e.g., caution) level may indicate a state of the battery as being degraded (e.g., continuously degraded) and a temperature of the battery as having increased or a voltage as being unstable, and signal the first vehicle to stop, and/or the driver of the first vehicle to call a service center or expert to take action.

The third (e.g., dangerous) level may indicate a particular battery state (e.g., a serious battery state) in which an action (e.g., an urgent action) may be required, indicate that a temperature of the battery is increased over a threshold (e.g., an ignition) temperature, and/or signal the driver to escape (e.g., immediately) from the first vehicle and notify nearby people of a risk.

In some embodiments, based on determining the situation (e.g., the abnormal situation) of the battery, information about the detected (e.g., abnormal) situation is output according to the severity level through the warning module 40 and the communication module 50 (S30).

In some embodiments, the communication module 50 may perform wireless transmission and reception with the surroundings (e.g., a surrounding second electric vehicle) using the 900 MHz ISM band.

In some embodiments, the processor 30 of the first vehicle detecting the situation (e.g., abnormal situation) outputs the information about the situation through the communication module 50. The processor 30 may transmit the detected severity level and location information of the first vehicle to warn a second vehicle. The second vehicle may receive the severity level and the location information of the first vehicle and determine a distance from the first vehicle based on the received location information, and move to a location outside a set range according to the severity level. In some embodiments, the higher the severity level, the larger the distance or range in which the second vehicle moves away from the first vehicle.

In some embodiments, the processor 30 of the first vehicle transmits the information about the detected (e.g., abnormal) situation through the communication module 50. The processor 30 may perform encryption and transmission of the information based on a public key and a private key together with a unique authentication key of the first vehicle. In some embodiments, if the processor 30 transmits the information about the abnormal situation of the battery and encryption is performed through the private key, the receiving second vehicle performs decryption through the public key, and validity of the received signal may be verified. Further, the reliability of the signal may be secured, and malfunction may be prevented.

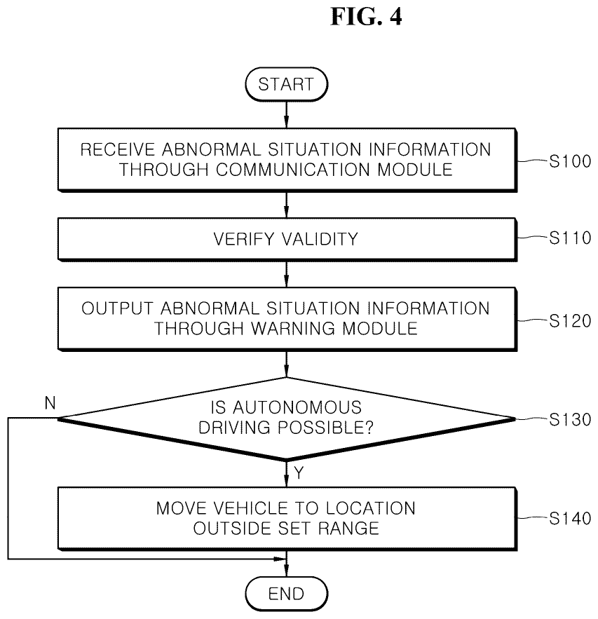

FIG. 4 is a flowchart of an example method for managing a detected (e.g., an abnormal) situation of an electric vehicle battery according to another embodiment of the present disclosure.

As illustrated in FIG. 4, in the method for managing a detected (e.g., an abnormal) situation of an electric vehicle battery according to one embodiment of the present disclosure includes the processor 30 of a receiving vehicle executing an execution program stored in the memory 20, and receiving information about the detected (e.g., abnormal) situation of a battery at a transmitting vehicle from the communication module 50 (S100).

In some embodiments, the communication module 50 may perform wireless transmission and reception with the surroundings using a 900 MHz ISM band.

In some embodiments, if the processor 30 receives the information about the detected (e.g., abnormal) situation of the battery, the processor 30 verifies validity of a signal received through the communication module 50 by decrypting the received signal (S110).

In some embodiments, if the processor 30 receives the information about the detected (e.g., abnormal) situation information through the communication module 50, the processor 30 may verify the validity of the signal by decrypting the received signal using a public key.

In some embodiments, based on verifying the validity of the signal, the processor 30 outputs the received information about the detected (e.g., abnormal) situation through a warning module 40 according to the received severity level indicative of the detected (e.g., abnormal) situation of the battery and a location of the vehicle transmitting the information (S120).

In some embodiments, the severity level is a first (e.g., warning), a second (e.g., caution), or a third (e.g., danger) level. The first (e.g., warning) level may indicate an initial state in which a temperature of the battery exceeds a normal range or an unstable state of a voltage occurs, and signals a driver of a detected (e.g., an abnormal) symptom to prompt the driver to take an action in advance or in response to the signal. The second (e.g., caution) level may indicate a state of the battery as being degraded (e.g., continuously degraded) and a temperature of the battery as having increased or a voltage as being unstable, and signal the transmitting vehicle to stop as soon as possible, and/or the driver of the transmitting vehicle to call a service center or expert to take action. The third (e.g., dangerous) level may indicate a particular battery state (e.g., a serious battery state) in which an action (e.g., an urgent action) may be required, and indicate that a temperature of the battery (e.g., in the transmitting vehicle) is increased over a threshold (e.g., an ignition) temperature, and/or signal the driver (e.g., of the transmitting vehicle) to escape (e.g., immediately) from the vehicle and notify nearby people of a risk.

In some embodiments, based on determining based on the location information of the transmitting vehicle that the severity level is the third (e.g., dangerous) level, and the receiving vehicle is located within a range (e.g., a dangerous range), the processor 30 of the receiving vehicle generates a warning through the warning module 40 (S120).

In the embodiment where the receiving vehicle is provided with the autonomous driving module 60, the processor 30 determines whether autonomous driving is possible (S130).

Based on determining that the autonomous driving is possible, the processor 30 sets a location (e.g., a safe location) outside a set range as a destination for the receiving vehicle based on the location information of the transmitting vehicle, and drives the autonomous driving module 60 to move the receiving vehicle to the destination (S140).

As described above, according to the apparatus and method for managing a situation (e.g., an abnormal situation) of an electric vehicle battery according to the embodiments of the present disclosure, an abnormal situation of a battery can be determined, a dangerous situation can be alerted to the surroundings, the surroundings can react to the dangerous situation, and a response ability can be improved. When the abnormal situation of the battery is alerted to the surroundings, since abnormal situation information of the battery is encrypted and alerted, the reliability of a signal can be secured, and a malfunction can be prevented. When a vehicle capable of autonomous driving receives the abnormal situation information of the battery, a dangerous situation can be avoided, and an accident risk can be reduced.

According to one or more embodiments of the present disclosure, an abnormal situation of a battery can be determined, a dangerous situation can be alerted to the surroundings to cope with the dangerous situation so that a response ability can be improved.

In addition, according to one or more embodiments of the present disclosure, if an abnormal situation of a battery is alerted to the surroundings, encryption can be performed on the abnormal situation information, the encrypted abnormal situation information can be transmitted, and thus the reliability of a signal can be secured, and a malfunction can be prevented.

In addition, according to one or more embodiments of the present disclosure, if a vehicle capable of autonomous driving receives abnormal situation information of a battery, a dangerous situation can be avoided, and an accident risk can be reduced.

However, aspects and effects which can be achieved through the present disclosure are not limited to the above-described aspects and effects, and other aspects and effects which are not described above will be clearly understood by those skilled in the art from the above description of the present disclosure.

Term “module” used in the present specification may include a unit implemented using hardware, software, and/or firmware and may be interchangeably used with the term “logic,” “logical block,” “component,” or “circuit.” A module may be an integrally formed component or a minimum unit or a part of the component that performs one or more functions. For example, a module may be implemented as a type of application-specific integrated circuit (ASIC) according to one embodiment of the present disclosure.

One or more embodiments of the present disclosure described in this specification can be implemented through, for example, a method, a process, an apparatus, a software program, a data stream, and/or a signal. Even when embodiments of the present disclosure are described as being implemented in only a single form (for example, as a method), the described features may be implemented in another form (for example, as an apparatus or program). The apparatus may be implemented using proper hardware, software, firmware, and/or the like. For example, the method may be implemented in an apparatus such as a processor which is generally a processing device such as a computer, a microprocessor, an integrated circuit, or a programmable logic device. The processor includes a communication device such as a computer, a cell phone, a portable/personal digital assistant (PDA) terminal, and other devices which facilitate communication of information between end-users.

While the present disclosure has been described with reference to some example embodiments illustrated in the accompanying drawings, the embodiments are merely exemplary. It will be understood by those skilled in the art that various modifications and other equivalent embodiments may be made from the embodiments of the present disclosure.

Therefore, the scope of the present disclosure will be defined by the following claims, and equivalents thereof.

What is claimed is:

1. An apparatus for managing a situation of an electric vehicle battery, the apparatus comprising:
a battery management module configured to monitor a state of the battery mounted in a vehicle;
a communication module configured to transmit or receive information about the situation of the battery to or from a surrounding;
a warning module configured to warn of the situation of the battery; and
a processor operatively coupled to the battery management module, the communication module, and the warning module,
wherein the processor is configured to determine the situation based on state information of the battery received from the battery management module, and output the information about the situation through at least one of the warning module or the communication module.

2. The apparatus of claim 1, wherein the state of the battery includes at least one of a temperature, a voltage, or a charging state of the battery.

3. The apparatus of claim 1, wherein the communication module is configured to perform wireless transmission and reception with the surrounding using a 900 MHZ industrial scientific medical (ISM) band.

4. The apparatus of claim 1, wherein the processor is configured to:
classify the situation of the battery according to a level; and
determine a severity level.

5. The apparatus of claim 4, wherein the processor is configured to transmit the severity level and location information of the vehicle through the communication module.

6. The apparatus of claim 1, wherein the processor is configured to:
encrypt the information with an authentication key of the vehicle and transmit the information through the communication module; and
verify validity of a received signal.

7. The apparatus of claim 6, wherein the processor encrypts the information based on a public key and a private key.

8. The apparatus of claim 1, further comprising an autonomous driving module configured to autonomously drive the vehicle,
wherein, based on the processor receiving a second information about a second situation of a second battery from a second vehicle through the communication module, the processor is configured to drive the autonomous driving module to move the vehicle to a location outside a set range.

9. A method of managing a situation of an electric vehicle battery, the method comprising:
receiving, by a processor, state information of the battery mounted in a vehicle from a battery management module;
determining, by the processor, the situation based on the state information of the battery; and
outputting, by the processor, information about the situation through at least one of a warning module or a communication module based on determining the situation.

10. The method of claim 9, wherein the state information of the battery includes at least one of a temperature, a voltage, or a charging state of the battery.

11. The method of claim 9, wherein the communication module performs wireless transmission and reception with a surrounding using a 900 MHz industrial scientific medical (ISM) band.

12. The method of claim 9, wherein the determining of the situation includes:
classifying, by the processor, the situation of the battery according to a level; and
determining a severity level.

13. The method of claim 12, wherein the outputting of the information about the situation incudes transmitting, by the processor, the severity level and location information of the vehicle through the communication module.

14. The method of claim 9, further comprising encrypting, by the processor, the information with an authentication key of the vehicle and transmitting the information through the communication module.

15. The method of claim 14, wherein the encrypting includes encrypting, by the processor, the information based on a private key.

16. A method of managing a situation of an electric vehicle battery, the method comprising:
receiving, by a processor, information about the situation of the battery from a communication module; and
outputting, by the processor, the information about the situation through a warning module in response to the receiving of the information about the situation of the battery.

17. The method of claim 16, wherein the communication module performs wireless transmission and reception with a surrounding using a 900 MHz industrial scientific medical (ISM) band.

18. The method of claim 16, wherein the receiving of the information about the situation of the battery further includes verifying, by the processor, validity of the information by decrypting a signal received through the communication module.

19. The method of claim 18, wherein the verifying of the validity includes decrypting, by the processor, the signal based on a public key.

20. The method of claim 16, further comprising driving, by the processor, an autonomous driving module to move a vehicle to a location outside a set range according to a severity level based on receiving of the information about the situation of the battery.
